(19) United States
(12) Patent Application Publication
(10) Pub. No.: US 2022/0333021 A1
(43) Pub. Date: Oct. 20, 2022

(54) PROCESS FOR OBTAINING ALKYL-NAPHTHENICS

(71) Applicant: PETRÓLEO BRASILEIRO S.A. - PETROBRAS, Rio de Janeiro (BR)

(72) Inventors: Rafael MENEGASSI DE ALMEIDA, Rio de Janeiro (BR); Carlos Rene KLOTZ RABELLO, Rio de Janeiro (BR); Carlos Alberto DE ARAUJO MONTEIRO, Rio de Janeiro (BR)

(21) Appl. No.: 17/659,821

(22) Filed: Apr. 19, 2022

(30) Foreign Application Priority Data
Apr. 19, 2021 (BR) 10 2021 007444 2

(51) Int. Cl. C10G 45/52

(52) U.S. Cl. CPC C10G 45/52; C10G 2400/04; C10G 2400/08; C10G 2400/30

(57) ABSTRACT

The present invention addresses to a process for the production of alkyl-naphthenics for use as diesel and/or aviation kerosene (JET A-1), whose process involves the alkylation of olefins with monoaromatics and subsequent hydrogenation to alkyl-naphthenics. The process and catalysts of the present invention allow the regeneration of the acidic catalyst with a hydrogenating function and full recovery of its activity with hydrogen hot stripping. The catalyst is used for the formation of intermediate alkyl-aromatics and can also be used in the subsequent hydrogenation to alkyl-naphthenics.

### FIELD OF INVENTION

The present invention addresses to a process for the production of alkyl-naphthenes, from charges containing olefins and aromatics, for use as diesel and/or aviation kerosene (JET A-1) aiming at improving product quality and volume gain.

### DESCRIPTION OF THE STATE OF THE ART

There is a need in the art to adapt oil refining to reduce emissions, obtaining the maximum of distillates of interest with less crude refining. Ideally, refining would produce exactly the most demanded derivatives, in the proportion desired by the market. There is a trend towards a decrease in gasoline consumption—either by substitution with ethanol or by electrification—while the consumption of diesel and JET A-1 remain relevant and with a tendency to increase. Therefore, there is interest in processes that take advantage of light streams and naphtha constituents of gasoline and transform them into diesel and JET A-1.

Conversion processes, such as FCC (fluidized bed catalytic cracking) and delayed coking, produce significant amounts of olefinic and aromatic streams, such as liquefied petroleum gas (LPG), FCC naphtha (NFCC), LCO (Light Cycle Oil), light coke naphtha (NLK) and light coke diesel (GOLK). Other conversion processes, such as hydrocracking (HCC), also show insufficient selectivity, with a significant amount of naphtha generated and large consumption of hydrogen. In fact, there is greater potential to produce lights, olefins and aromatics in the FCC than derivatives in the diesel and JET A-1 range. Furthermore, the use of high-octane ethanol in the gasoline pool reduces the demand for catalytic reforming units.

There are processes for converting olefinic LPG into gasoline and distillates, such as oligomerization and alkylation of isobutane and isopentane. However, only light olefins are more easily converted in the case of oligomerization, and the main yields are in the gasoline range. In the case of the alkylation of isoparaffins, isobutane (and optionally isopentane) is reacted with C4= (and optionally C3=) olefins, mainly producing gasoline.

The alkylation of aromatics has the potential to convert the reformate streams, olefinic LPG and naphthas from FCC and coke. FCC naphtha typically has 30 wt % olefins plus 40% aromatics, while a catalytic reform naphtha has 70 wt % aromatics. The potential to shift these streams from the gasoline range to the JET A-1 and diesel range can reach more than 70% by mass of the streams, even considering the use of external olefins such as LPG.

The remaining unreacted products, paraffins and naphthenics, can be reprocessed in catalytic cracking and/or catalytic reforming, generating more olefins and aromatics for conversion to diesel and JET A-1.

The alkylation of aromatics is widely used in the production of petrochemical derivatives such as cumene, ethyl-benzene, para-xylene, and LABs (linear alkyl-benzenes) for the manufacture of detergents. In these processes, with charges without contaminants, high recycle of aromatics diluting the olefins, an operation with heterogeneous acidic catalysts is possible for longer periods and the usual catalyst regeneration strategies are sufficient.

Alkylation of aromatics, followed by hydrogenation to alkyl-naphthenes, to improve properties such as density and cetane, could significantly decrease gasoline and LPG and increase diesel and JET A-1 production.

However, the use of alkylation in refining is limited, due to the severe deactivation of heterogeneous acidic catalysts. This deactivation results not only from the presence of contaminants in the charge, especially nitrogen and sulfur, but also from the parallel polymerization reaction of olefins and dienes, resulting in the obstruction of access to active sites, and difficulty in diluting olefins in charge streams where both are present.

The art teaches the use of alkyl-aromatics and alkyl-naphthenes as components of diesel and JET A-1.

US patent application 2006/0194998 teaches that the claimed aromatics alkylation process can produce middle distillates such as aromatic diesel and a component for JET A-1.

U.S. Pat. No. 7,504,548 teaches the use of alkyl-aromatics as a diesel component or additive. The alkyl-aromatics would be obtained from the aromatic fraction of gasoline at 80 to 120° C., plus olefins from 7 to 20 carbons. The patent further teaches that the hydrogenation of alkyl-aromatics to alkyl-naphthenics is advantageous, with significant increases in the cetane number of the components.

U.S. Pat. No. 4,992,606 teaches the alkylation of aromatics from a reforming stream with light olefins (propene) from refinery streams to reduce benzene from gasoline. U.S. Pat. No. 5,491,270 further claims the use of FCC naphthas as the sources of olefins, thermal cracking, coking and pyrolysis.

WO 2000/039253 teaches that aromatic streams such as LCO (Light Cycle Oil), a range of diesel from the FCC, can be reacted with olefins, preferably FCC light naphtha (NLFCC), to increase the number of cetane (and cetane index) of the stream, improve the density and the total volume, facilitating its later refining, and decreasing the need for hydrogen consumption from the hydrogenation of olefins.

U.S. Pat. No. 5,171,916 teaches the alkylation of LCO with coke diesel as a source of olefin.

U.S. Pat. No. 4,594,143 also teaches the alkylation of aromatics in the stream in the JET A-1 range with light olefins to produce an alkyl-aromatic distillate in the diesel range, with increased cetane number compared to unalkylated.

U.S. Pat. No. 4,871,444 also teaches the alkylation of LCO with olefins of 5 to 7 carbon atoms, preferably 1-olefins.

As there is an advantage in the cetane number with an increase in the alkyl chain in aromatics (and alkyl-naphthenics), the application US 2011/0147263 teaches the oligomerization of light olefins (C2-C6) prior to alkylation with aromatics. U.S. Pat. No. 2,519,099 also teaches a silica-alumina with NiO that allows oligomerization of ethylene in combination with alkylation.

U.S. Pat. No. 8,071,829 claims the fractionation and reaction of lighter portions of FCC naphtha in Beta zeolite, since the alkylation of the entire naphtha shows significantly greater deactivation, with the light fractions reacting with 6 and 7 carbon aromatics and with 5 and 6 carbons olefins.

Some patents teach the conversion of refinery streams containing olefins and/or aromatics, such as reformate, FCC naphtha, coke naphtha and LCO. However, most of the art addresses to the reaction of benzene with ethylene or propylene, with the purpose of producing ethyl-benzene and cumene.

The art teaches that, in general, Bronsted or Lewis acidic catalysts are usable, such as HF, AlCl₃, H₂SO₄, BF₃, and heterogeneous acidic solids such as silica-alumina, molecular sieves and mixed oxides. Catalysts such as HF, H₂SO₄, BF₃ and AlCl₃ and combinations, even if supported, have several disadvantages such as corrosivity, safety hazards associated with the use, acid consumption and disposal, wherein there has been sought in the art the development of heterogeneous acidic solids that do not present such disadvantages.

Aluminosilicates, amorphous or crystalline are mainly used as alkylation catalysts. Only in the patents mentioned above, the application US 2006/0194998 teaches the use of catalysts as molecular sieves of the MWW type, wherein the MCM-22, MCM-36, MCM-49, MCM-56, SSZ-25, ERB-1, ITQ-1, PSH-3 and others can be mentioned, wherein MCM-22 is preferred. U.S. Pat. No. 7,504,548 teaches the use of mordenite, zeolite Y, in addition to AlCl₃. Document WO 2000/039253 claims solid acidic catalysts in general, specifically USY, MCM-22 and MCM-56. U.S. Pat. No. 5,171,916 claims beta, MCM-22 and US-Y zeolites. U.S. Pat. No. 4,954,143 claims zeolites containing pores from 6 to 15 Angstrom, among them ZSM-4 or ZSM-12. U.S. Pat. No. 4,871,444 claims the ZSM-20 zeolite. Application US 2011/0147263 also teaches the use of MWW-type alkylation catalysts, such as MCM-22 and MCM-49, and the oligomerization step of solid phosphoric acid (SPA)-type catalysts, MWW (MCM-22, MCM-36, MCM-49, MCM-56, EMM-1, EMM-2 or a combination) and ZSM (ZSM-22, ZSM-23, ZSM-57 and a combination). A number of other molecular sieves, zeolites, are used in the art of alkylation, and the patents of the CPC Class (Cooperative Patent Classification) C07C2/66 can be listed.

In addition to molecular sieves with large pores, several other solid catalysts are also used in the art of aromatic alkylation. There may be mentioned silica-alumina (SiO₂/Al₂O₃), as taught by U.S. Pat. Nos. 4,990,718 and 2,410,111, optionally with ZrO₂ in place of Al, as taught by U.S. Pat. No. 2,410,111, or other metals such as Mg, Th, B and Zr, U.S. Pat. No. 2,972,642, silica-gel impregnated with hydrolysable aluminum salt, U.S. Pat. Nos. 2,419,599 and 2,319,796. In addition to silica and alumina, other refractory oxides can be mixed resulting in acidic solids, combinations of Si, Al, Zr, Mg, Th, B, according to U.S. Pat. Nos. 2,418,028 and 2,448,160. Various treatments of SiO₂/Al₂O₃ to increase acidity are also claimed, such as sulfonation or chlorination, U.S. Pat. No. 3,336,410. Another functionalization is fluorination, resulting in contents of 1 to 5% F, U.S. Pat. Nos. 3,084,204, 5,196,574, 5,302,732, and may also have additional metal cations and halides, in addition to an additional zero valence metal, as U.S. Pat. No. 5,962,760 teaches. U.S. Pat. No. 3,169,999 teaches the addition of Ni and Cr in silica-alumina, while U.S. Pat. No. 4,335,022 teaches aluminum on SiO₂. Other known acidic catalysts are Ni and Cu molybdites, as per U.S. Pat. No. 2,572,019, Zr halides in ZrO₂ as U.S. Pat. No. 292,108, tungstate modified zirconia, U.S. Pat. No. 5,516,954, W₂O₅ in silica, U.S. Pat. No. 3,153,677, ammonium metatungstate, activated by heating in a reducing atmosphere, U.S. Pat. No. 4,358,628, Re-oxides reduced to lower valence, supported on SiO₂, Al₂O₃, SiO₂/Al₂O₃, ZrO₂, TiO₂, according to U.S. Pat. No. 3,342,887. Others are mixtures of Al₂O₃+B₂O₃+oxides from groups IVA or VIIB, according to U.S. Pat. No. 4,219,690. Other class of catalysts are heteropolyacids, as taught in U.S. Pat. Nos. 3,723,552, 5,382,735, 5,254,766. Clays are also used, such as acid activated bentonites, U.S. Pat. No. 2,945,072, activated montmorillonites, U.S. Pat. Nos. 2,930,819 and 2,930,820, stabilized pillared clays, U.S. Pat. Nos. 4,665,220, 5,034,564, 5,491,271, clays coextruded with multivalent metals from Groups IIIA, IIIB, IVB, such as montmorillonite with alumina and ceria nitrate up to 3%, as taught by U.S. Pat. No. 5,043,511. Other acidic solids are ion exchange resins, sulfonated, of polystyrene with divinylbenzene, U.S. Pat. Nos. 3,037,052, 3,239,575, or even carbonized, U.S. Pat. No. 8,017,724. Other acidic resins are perfluorosulfonic acids, the “Nafion”, U.S. Pat. Nos. 4,022,847, 4,317,949, 4,065,515, 4,060,565, optionally with anions, U.S. Pat. No. 4,446,329, in composite with SiO₂, U.S. Pat. No. 6,281,400, and composite with SiO₂ and metal oxide, U.S. Pat. No. 6,784,331.

The multiplicity of catalysts shows that virtually any acidic catalyst lends itself to the alkylation reaction, with greater or lesser activities, advantages and disadvantages. It is known in the art that the biggest problem is the deactivation of acidic catalysts. Deactivation takes place through several mechanisms, namely: (a) poisons, (b) deposit of less volatile products, formed as by-products or carried in the charge, (c) by aging and structural changes, such as sintering, recrystallization, transport reactions/replacement. Known specific poisons are nitrogenous, sulfuric and oxygenated, polar compounds in general, adsorbing on active sites and preventing access. Nitrogenates are mainly deleterious, especially in molecular sieves. The alkylation reactions can take place in the gas phase, in the vapor+liquid phase, fully in the liquid phase or even in the supercritical phase. U.S. Pat. No. 4,721,826 teaches that, while in gas, partial liquid or even liquid phases there are problems of deposition of less volatiles, in the supercritical phase, above the Tc and Pc of the mixture, the transport of these materials formed out of the catalyst is facilitated, decreasing the deactivation or even recovering the activity. Also, U.S. Pat. Nos. 5,866,733, 6,376,729, 6,630,606, US 2004138511, U.S. Pat. No. 7,419,929, US Application 2009203862, US Application 2008058567, US Application 2010009842 teach the importance of liquid or preferably supercritical phase during operation and/or regeneration. Another important point is to design the catalyst with easy access: porosity, dimensions and shape of the catalyst, arrangement in the bed.

The less volatile liquids are mainly oligomers/polymers formed by the polymerization of olefins and dienes (more reactive) present in the olefinic charge. To reduce the parallel oligomerization reaction, the art teaches working with aromatic in excess, preferably fractionating the product and sending the unreacted aromatic to the charge. Furthermore, the art generally teaches to inject olefins into several reactors or injection points in a reactor, which increases the aromatic/olefin ratio in the injection bed. It also teaches a myriad of catalytic distillation schemes, resulting in increased aromatic/olefin ratio. The aromatic/olefin ratio is also increased when a mono-alkylation product is desired, to increase selectivity. Examples of patents claiming staged olefin injection are U.S. Pat. Nos. 2,572,701, 4,107,224, 4,992,607, 5,792,894, 6,057,485, 6,232,515, 6,281,399, 7,923,590, 8,395,006, 98,281,907, 393,007, 3,930,053.

The partial hydrogenation of dienes to olefins, prior to contact with acidic catalysts, is also known in the art.

In addition to the recycle as discussed, schemes with transalkylation reactors are also used in the art, where polyalkyl (and even dialkyl-aromatics) are reacted with aromatics, to increase the selectivity of the desired product, or even isomerization, to change the position of the alkyl groups in the aromatic.

Another strategy to decrease deactivation is the adequacy of catalyst activity to decrease coke deposition. Silanization (silicone treatment) is widely employed to remove acidity from the surface (but not within the pore) of zeolitic catalysts/molecular sieves, or even the addition of phosphorus. Another strategy is coke deposition, changes in the nature of zeolite such as ion exchange, control of the number of active sites and acidity level, etc. As examples, but not limited to, the silanization of zeolite, U.S. Pat. No. 4,060,568, the addition of phosphorus (P), U.S. Pat. No. 3,962,364, an initial, controlled coking as per U.S. Pat. No. 4,358,395, significant presence of mesopores and macropores (U.S. Pat. Nos. 5,146,026, 5,157,158), besides the infinity of nature of crystalline aluminosilicates (and other compounds replacing SiO₂ by Ge₀₂ and Al₂O₃ by B₂O₃, Cr₂O₃, Fe₂O₃ or Ga₂O₃, known in the art), different binders, ion exchanges e.g. modification with metals, Ce and La mainly, formulations with other metals, steam treatments, calcination under different conditions, dealumination, USY, REY, and others, as described in part in U.S. Pat. No. 5,399,337. The UZM-8 zeolite, for example, has sites of lower strength, and better distributed than mordenite, as U.S. Pat. No. 8,470,726 teaches.

Another way to decrease the deactivation of catalysts is the removal of poisons. U.S. Pat. Nos. 5,744,686 and 5,942,650 teach that the presence of nitrogenous compounds such as acetonitrile, propionitrile, acrylonitrile and mixtures are problematic, and that they can be removed with beds, prior to the alkylation reactor, of zeolites 4A, 4A of closed pore, 5A, silicalites, P-silicalites, ZSM-5 and mixtures, and a holdup tank (suggested 20 h) is also convenient to flatten contaminant peaks. U.S. Pat. No. 6,297,417 also teaches the use of a pre-treatment bed of aromatics, being selected from acidic aluminas, silicas, silica-aluminas, clays, zeolites and mesoporous aluminosilicates. US Application 2004192985 teaches the use of a composite guard bed, with a molecular sieve greater than 6 A at the beginning and less than 6 A at the end of the bed. US Application 2010268008 teaches the removal of nitrogenates from the olefin charge using regenerable adsorbent. US Application 2011230693 teaches that sulfur compounds also have a deleterious effect. U.S. Pat. No. 7,449,420 teaches the use of an adsorption method after the alkylation unit, in the distillation bottom stream after the reactor, using acidic clays, zeolites, molecular sieves, silicates, aluminas, activated aluminas, activated carbon, silica-gel and ion exchange resins as the adsorbent, and the polymers formed in the reaction are also absorbed. It is also convenient to carry out selective hydrogenation for the removal of dienes in the charges, even for protection of guard beds, as U.S. Pat. No. 8,350,106 teaches. US patent 2016652839 teaches the use of preliminary reactors in the lead/lag (swing) scheme reactors in parallel, while one adsorbs the contaminant, the other is regenerated (by steaming or burning), keeping less than 100 ppb of poisons in the subsequent alkylation charge. Another poison of particular attention is oxygen, especially in the presence of olefins and dienes, leading to the formation of peroxides and gum deposits. U.S. Pat. No. 5,300,722 teaches deaeration of the charges by distillation/stripping with inert gas and U.S. Pat. No. 5,866,738 teaches in addition to deaeration the use of oxygen removal catalyst (such as 6% Ag supported on Al₂O₃).

However, even with care to keep the operation in supercritical condition, maintain a high aromatic/olefin ratio, either by recycling and/or several olefin injection points throughout the reaction, having guard beds for poisons, it still occurs the deactivation of the catalyst by depositing material on the surface of the catalyst, also generically described as coking. Several strategies are employed for regeneration, and can be classified in general as: (a) oxidation of carbonaceous material (either by O₂, N₂+O₂, reaction with CO+CO₂), (b) heat treatment, steam, heated inert gas, (c) washing with the aromatic charge or paraffins, (d) washing with polar solvent, (e) treatment with hydrogen in the catalyst, and finally (f) treatment with hydrogen in the catalyst functionalized with hydrogenating and/or hydrogenolysis function. These regeneration strategies can further be employed in a continuous or semi-continuous way—stopping the use of a reactor or the whole unit, or further continuously regenerating the catalyst, or further injecting an amount of hydrogen continuously during the main operation of the reactors of alkylation.

The oxidation of carbonaceous material is taught by U.S. Pat. No. 4,463,209 (in the presence of at least up to 0.3 bar (30 kPa) steam), U.S. Pat. No. 5,145,817 (USY catalyst with rare earth and deposited Al salt). U.S. Pat. No. 6,864,399 teaches the oxidation regeneration of beta zeolite with SiO₂ binder at temperatures lower than 500° C. U.S. Pat. No. 6,781,025 teaches oxidation regeneration of MCM-22 catalyst at 120-600° C. and claims a post-treatment in aqueous phase with ammonium nitrate, ammonium carbonate and/or acetic acid to recover the activity lost in regeneration. U.S. Pat. No. 7,419,929 teaches Ce-promoted zeolite bed regeneration using N₂ at 300-310° C. until benzene is removed from the bed, and further addition of O₂ for final regeneration. In general, lower temperatures are preferred, preferably less than 500° C., although those up to 600° C. are claimed. Patent application US 2016038929 teaches the use of ozone for oxidation, which is more reactive and can be used at lower temperatures, from 50 to 250° C., reducing damages to the catalyst. U.S. Pat. No. 8,859,835 teaches the use of CO₂+CO for regeneration at temperatures greater than 400° C.

Heated gas regeneration is taught in U.S. Pat. No. 6,911,568, where the catalyst (MCM-22 or optionally MCM-36, 49 or 56) is regenerated with paraffinic hydrocarbons chosen between C1 to C8, the temperature being lower the larger the size of the chain. The patent claims as preferred a temperature of 540° C. for 12 h, using C3-C5 alkanes. US patent application 2009203862 teaches the use of super-atmospheric N₂ for catalyst rejuvenation. In the same way, U.S. Pat. No. 8,623,777 teaches the regeneration of a catalyst chosen from MCM-22, zeolites of the BEA, FAU, MOR type, without additional metals, at 400-600° C. with a gas chosen from N₂, alkanes, He, Ar, CO, CO₂ and finally H₂.

Regeneration or, more appropriately, partial recovery or rejuvenation of the catalyst, is also carried out with aromatic washing (usually benzene), which can simply be the suspension of the olefins in the charge. U.S. Pat. No. 2,541,055 teaches the recovery of the activity of silica-alumina used in the synthesis of cumene (benzene+C3=), for periods of operation without olefin; as an example, every 5 h of reaction (at 180-230° C., 35 bar (3.5 MPa) and LHSV of 1 h⁻¹) a flow of only benzene is maintained for 1 h. U.S. Pat. No. 4,219,690 teaches regeneration by washing with aromatic and/or other non-olefinic component, and, if still necessary for activity recovery, heating to 370° C. in the presence of H₂ or N₂. U.S. Pat. No. 5,118,897 teaches the use of catalysts such as zeolites X, Y, L, Beta, ZSM-5, omega, mordenite and chabazite, these being recovered in the presence of benzene and hydrogen; in the example, there is the use of 8 h⁻¹ benzene WHSV, temperature 220-270° C. and 28 bar (2.8 MPa) (but claims up to 430° C. and 200 bar (20 MPa)) plus 0.006 g H₂/g cat·h, for 10 h. U.S. Pat. No. 5,789,640 claims continuous operation of H—Y zeolite slurry bed alkylation unit, with aromatic wash regeneration at a temperature (165-175° C.) higher than the operating one (110-120° C.). In turn, U.S. Pat. No. 5,877,370 for alkylation with Beta zeolite uses benzene washing at 200-250° C. U.S. Pat. No. 6,255,549 teaches stream washing with at least 55% aromatics (but no olefins) in a liquid phase, at a temperature of 5 to 150° C. above normal operating temperature. U.S. Pat. No. 7,449,420 teaches the reactivation of the catalyst with benzene at a temperature of 10 to 200° C. above the operating temperature, in reactivation cycles from 12 h to 4 days, and sending the benzene contaminated with heavy components to the distillation for purging and optionally another bed of adsorption. Similarly, US 2005003949 teaches that while a reactor is reactivated with benzene, which in turn is purified by distillation and sent back to another reactor that operates the alkylation in parallel; it also teaches how to monitor the reactivation by the Saybolt color of the effluent. The same operation in lead-lag or swing bed (one reactor alkylating and the other reactivating) is taught by U.S. Pat. No. 8,058,494, with cycles from 20 to 100 h. The same reactivation of the catalyst with benzene at 220-260° C., in lead-lag is taught by U.S. Pat. No. 7,652,181. U.S. Pat. No. 7,576,247 teaches the regeneration, but with a differential of simplified distillation for recovery of benzene from the washing with low energy consumption, in the same way as the filing application US 2010234656. Also, the application US 2006009669 claims the regeneration of a mordenite with benzene. U.S. Pat. No. 9,732,014 also uses benzene in regeneration and reuses the same in alkylation. U.S. Pat. No. 7,541,505 teaches a moving bed reactor with regeneration by washing with benzene and partially oxidizing the catalyst.

Other ways of recovering catalyst activity known in the art involve the washing with polar solvents. U.S. Pat. Nos. 5,146,026 and 5,157,158 teach cyclic regeneration with paraffins and then alcohols, for 2 to 8 h and 150 to 300° C., with LHSV from 1 to 10 h⁻¹. U.S. Pat. No. 6,909,026 claims the use of polar solvents with a dipole moment greater than 0.05 Debye, such as acetic acid, formic acid, water, CO, under conditions of T and P equal to those used in alkylation.

Regeneration of catalysts with H₂, or operation with the same and less deactivation, is also known in the art.

U.S. Pat. No. 3,104,268 teaches the functionalization of silica-alumina with ZnO+CuO/Cr₂O₃ for alkylation in the presence of H₂, with a H₂:aromatic ratio from 1:1 to 1:20 mol:mol, with less carbon deposition on the catalyst.

U.S. Pat. No. 3,763,260 teaches the alkylation of an aromatic using mordenite plus a metal chosen from Cu, Ag, Au and Zr, in the presence of H₂ during alkylation or transalkylation.

U.S. Pat. No. 3,851,004 teaches the functionalization of a molecular sieve with a metal chosen from Ni, Pt, Pd, Ru and Rh, with a regeneration using saturated hydrocarbon (from 4 to 12 carbons), with at least 0.1 mol % of H₂, at a temperature of up to 300° C. and lower than 350° C., which would lead to the formation of refractory coke. U.S. Pat. No. 4,008,291 teaches the functionalization of zeolite with a metal from Group VIII, preferably selected from Ni, Pt, Pd, Rh and Ru, and regeneration with iC4 with dissolved H₂, in a SMB (Simulated Moving Bed) reactor.

U.S. Pat. Nos. 4,358,395 and 4,508,836 teach the alkylation operation with a zeolitic catalyst, preferably ZSM-5, with regeneration in a H₂ atmosphere from 425 to 650° C. and pressure of up to 138 bar (13.8 MPa), from 1 to 48 h.

U.S. Pat. No. 4,992,607 teaches the alkylation of aromatics (reformate C6-C8 cut) by C2-C3 olefins with zeolitic catalyst (ZSM-5) in a riser, with regeneration with H₂ in a fluidized bed; part of the catalyst can also be regenerated by oxidation.

U.S. Pat. Nos. 5,475,179 and 5,571,768 teach the use of H₂ during alkylation with ZSM-5 catalyst, with 0.05% Pt and regeneration only with H₂, from 350 to 540° C., and pressure from 1 to 340 bar (0.1 to 34 MPa) (typically 35 bar (3.5 MPa)).

U.S. Pat. Nos. 5,489,732, 5,672,798 and 5,675,048 claim the alkylation without H₂ and initial regeneration with washing in liquid phase (aromatics) in parallel with treatment with hot H₂ (hot stripping), in a continuous fluidized bed reactor.

U.S. Pat. No. 8,071,828 claims a molecular sieve with at least one metal from the group Pt, Pd, Ir, Re, from 0.01 to 5% w/w; and at least one additional metal selected from Cu, Ag, Au, Ru, Fe, W, Mo, Co, Ni, Sn and Zn, from 0.01 to 1% w/w of the metal, the regeneration being carried out with H₂.

U.S. Pat. No. 9,314,779 teaches the use of zeolite with a metal from Group VIII, from 0.03 to 5% w/w of the catalyst, and optionally alkylation with hydrogen, resulting in less deactivation.

Even after other catalyst regeneration/rejuvenation schemes, oxide regeneration may be required.

The art also teaches that some olefins lead to greater deactivation, for example isobutene, according to U.S. Pat. No. 5,756,873. The art further suggests that olefinic charges of different molecular weights be separated, since different selectivity results in greater deactivation, with the preferred separate processing.

Despite the current and future use of JET A-1 and diesel, there is no defined, advantageous process for their production, from lighter streams containing aromatics and olefins, either due to differences in reactivity of olefins of different natures, presence of contaminants in the charges, high deactivation, regeneration difficulties, and the need for an additional hydrogenation step from alkyl-aromatics to alkyl-naphthenics. The absence of a more favorable process for obtaining it is evidenced by the multiplicity of inventions in the art.

Accordingly, in order to solve such problems, the present invention was developed, through which there is the production of JET A-1 and diesel through the alkylation of aromatics and olefins from refinery streams, with subsequent regeneration and hydrogenation to alkyl-naphthenics.

The present invention consists of acidic catalysts for alkylation of aromatics, easily regenerated by hydrogen contact at higher temperatures, at typical alkylation operating pressures, when in addition to metals from Group 10, such as Pt and Pd, there are present in the catalyst metals from group 9 such as Rh and/or metals from group 7 such as Re.

Also, the same catalyst can hydrogenate the alkyl-aromatics formed to alkyl-naphthenics, reducing the complexity of the unit.

Therefore, the present invention allows the processing of charges with a low aromatic/olefin ratio, easily recovering the alkylation activity either by hydrogenation of the product and/or hydrogen hot stripping.

### BRIEF DESCRIPTION OF THE INVENTION

The present invention addresses to a process for the production of alkyl-naphthenes for use as diesel and/or aviation kerosene (JET A-1).

The process involves the alkylation of olefins with monoaromatics and subsequent hydrogenation to alkyl-naphthenics. The process and catalysts of the present invention allow the regeneration of the acidic catalyst with hydrogenating function and full recovery of its activity with hydrogen hot stripping. The catalyst is used for the formation of intermediate alkyl-aromatics and can also be used in the subsequent hydrogenation to alkyl-naphthenics.

The process allows the use of olefinic and aromatic charges, such as ethene, propene, olefinic liquefied petroleum gas (LPG) from the catalytic cracking unit (FCC), FCC naphtha, coke naphtha, pyrolysis gasoline and catalytic reform (reformate) naphtha, in addition to LCO and coke diesel as sources of aromatics and olefins.

### BRIEF DESCRIPTION OF DRAWINGS

The present invention will be described in more detail below, with reference to the attached figures which, in a schematic way and not limiting the inventive scope, represent examples of the embodiment thereof. In the drawings, there are:

FIG. 1 illustrating the process scheme of the invention, with at least 3 reactors, where there are represented the olefinic charge (1), the aromatic charge (2), the alkylation reactor in operation (10), the alkylation product (11), the fractionator (20), the recycle of unreacted aromatics (22), the non-olefinic lights (21), the alkylate (23), the hydrogen for hydrogenation (3), the alkyl-aromatics hydrogenation reactor (30) and the alkyl-naphthenic product (31), as well as the regenerating hydrogen (4) and the regenerating reactor (40), loaded with the alkylation catalyst claimed in the present invention;

FIG. 2 illustrating the results of tests of different catalysts for alkylation, comparing the conversion of olefins with the yield in aromatics;

FIG. 3 illustrating the deactivation comparison for the various alkylation catalysts of the invention;

FIG. 4 illustrating the deactivation for catalyst A, with recoveries of activity by sequences of hydrogen hot stripping and oxide regeneration;

FIG. 5 illustrating the deactivation for catalyst C, with recoveries of activity by hydrogen hot stripping sequences.

### DETAILED DESCRIPTION OF THE INVENTION

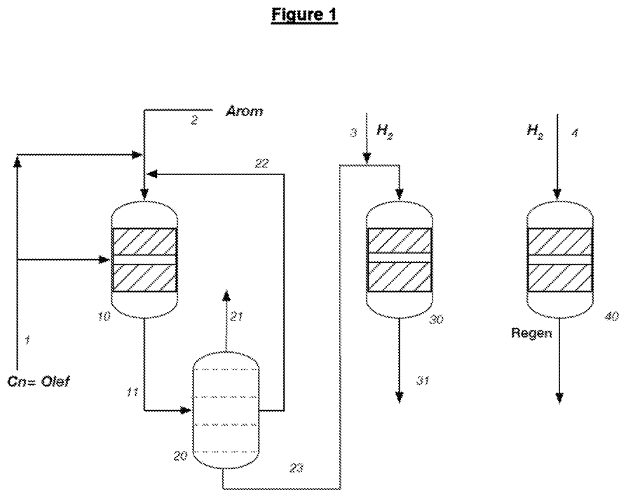

The process of producing aviation kerosene (JET A-1) and diesel from charges containing olefins and aromatics according to the present invention and illustrated in FIG. 1 consists of:
(a) carrying out the alkylation reaction of aromatics with olefins with the acid-supported alkylation catalyst with at least one metal from Group 10 of the Periodic Table of Elements, plus at least one metal from Group 9, such as the Rh, and/or Group 7, like Re;
(b) carrying out the reaction of regenerating the activity of the alkylation catalyst by contacting H₂ at a temperature higher than the alkylation of step (a);
(c) reusing the alkylation catalyst for step (a).

Olefins and aromatics can be present in different charges, fed to the same process, such as LPG from the FCC unit, and the reformate from the Catalytic Reform Unit (CRU). Alternatively, some charges may contain olefins and aromatics already in their composition, such as NFCC.

Useful charges existing in the refinery, which can be used in the process of the present invention, are charges containing olefins and/or aromatics in any proportion. FCC gas (containing olefins such as C2= and C3=), LPG from FCC (C4=), NFCC, LCO, coke naphtha (NLK), coke diesel, thermally cracked or pyrolysis gasolines/naphthas can be mentioned.

The conversion of olefinic and aromatic streams in the gasoline range makes room for the unreacted portions of these streams, of paraffinic and naphthenic nature, to be reprocessed at the FCC, for example, to produce more olefins and aromatics. This combination of FCC alkylation, for example, can essentially zero gasoline production in a refinery, offering maximum flexibility for the refining plant, significantly increasing diesel and JET A-1 production.

The present invention is characterized by the acid site reaction of a heterogeneous catalyst of aromatics with olefins (and dienes, when present).

Charge treatments and purifications can be used, such as providing adsorption means for nitrogenous, oxygenated, polar compounds in general, present in the charges. Another problematic component that leads to blockage of catalyst pores are dienes, which polymerize easily, even more so in the presence of oxygen.

However, given the regeneration capacity facilitated by the present invention, it is possible to operate without treatment of charges, simply by adjusting the frequency of regeneration operations.

Alternatively, a step of selective hydrogenation of dienes can be envisaged. In a possible configuration of the invention, the catalyst of the present invention itself, under liquid phase conditions and lower temperature, can hydrogenate the charge dienes to olefins, prior to contacting the same catalyst in a higher temperature alkylation condition. Catalysts for selective hydrogenation are known in the art, usually supported metals from Group 10 of the Periodic Table.

Different modes of operation of alkylation, regeneration, and hydrogenation are possible, to obtain the highest yield in the alkylation and hydrogenation reactions, accommodating the deactivation of the acidic function of the catalyst.

It is possible to alkylate the charges to a still acceptable level of catalyst activity, stop the reactor charge and align H₂, increasing the alkylation temperature to the desired regeneration temperature, and realign the charge. The hydrogenation can further be carried out on the same catalyst, and the activity is recovered with the hydrogenation itself. It is further possible to carry out a regeneration step in a shorter time just to recover the metallic sites of hydrogenation capacity, before hydrogenation, and allow the oligomers to be removed during the hydrogenation step. At the end of the hydrogenation, the catalyst can be operated again for alkylation, and an additional step of hot stripping with H₂ may occur before aligning the alkylation charge.

Alternatively, the hydrogenation catalyst of the alkyl-aromatics may be different from the alkylation catalysts.

The degree of hydrogenation depends on the destination of the product. As diesel, the total hydrogenation of the monoaromatics present is preferable, mainly to improve the density and cetane. As JET A-1, the product may not be hydrogenated, or only partially, depending on the amount of stream that will compose the JET A-1 pool.

It is possible to operate the process with only one reactor, discontinuously.

It is more interesting, however, to provide means of having more than one reactor or operating bed. Thus, in a preferred arrangement of the present invention, while one reactor regenerates, the other alkylates, and a third hydrogenates. Or with 2 reactors and a larger LHSV in the hydrogenation, it is possible to regenerate a bed, and use the deactivated catalyst for the alkylation for the hydrogenation and resume the alkylation in the regenerated catalyst.

The preferred operation is with 3 reactors, while a reactor alkylates, a second reactor regenerates and a third reactor hydrogenates. There may also be a fourth reactor carrying out selective hydrogenation of dienes from the olefinic charge, prior to alkylation.

In the case of 3 reactors, as the regeneration times are shorter than the alkylation times, it is possible to use the regenerated catalyst for other functions, to work in line or in parallel, to use as a guard bed, with less conversion, or another function, such as cracking non-aromatic products to generate more olefins or a hydro-alkylation step. In hydro-alkylation, with aromatic charge plus sub-stoichiometric hydrogen generates olefinic alkyl-naphthenics, which can be alkylated to the remaining aromatics, generating diaryl-alkyl-aromatics.

Preferably, when there is a mostly olefinic charge separated from the aromatic charge, it is possible to inject the olefins along the beds of a reactor, with the reactor having at least 2 beds. The more beds, the smaller the deactivation, but with an increase in the complexity of the unit, there is an optimum to be determined by economic considerations.

The reactor may or may not have product recycle. Preferably the reactor has product recycle. Product recycle reduces the need for cooling between reactor beds, since the reaction is exothermic. Furthermore, it reduces the concentration of olefins and the undesirable side reactions of formation of oligomers from light olefins in the gasoline range. Another advantage of recycling is that it increases the amount of aromatics with more than one alkyl (dialkyl-aromatics, trialkyl-aromatics), increasing the boiling point, quality and quantity of the product. An additional advantage of promoting more than one alkylation of the same aromatic is being able to convert a greater amount of olefinic charge. Typically, the reactor recycle can be represented by the ratio between the amount of product that is fed back to the reactor inlet divided by the reactor charge. It can be from zero to 20, preferably from 0.1 to 2. Furthermore, before recycling there can be a separator. With a separator, which can be a flash or a set of flashes or a distillation or adsorption unit, only the unreacted aromatics are fed back to the reactor.

A higher content of aromatics in relation to the olefinic charge is advantageous, reducing the formation of oligomers when the olefinic charge is light (e.g.: C4=), disfavoring the formation of oligomers with higher yield in the gasoline range, being selective in the formation of alkylates in the range of JET A-1 and diesel.

In the hydrogenation step, product recycle is also advantageous, not only because of the decrease in exothermicity. It may be interesting to dimension the recycle in order to allow the reactor operation in liquid or supercritical phase in the hydrogenation step, provided by the liquid recycle, without the need for a gas recycle compressor, sending only the H₂ of chemical consumption to the unit. This allows higher reaction kinetics and higher rates of mass transfer in the reactor and less complexity of the unit, the pumping of liquid being more easily implemented than that of gas, as is known in the art.

Typical alkylation temperatures are temperatures from 100 to 400° C., preferably 150 to 350° C., more preferably 200 to 300° C., in general. Some catalysts, however, can operate at higher temperatures. What limits the temperature, however, to less than 500° C., is the possibility of sintering the catalyst metals. It is possible and desirable to start with high conversion and increase the temperature over the run time to extend the campaign time before regeneration.

Typical temperatures for hydrogenation of alkyl-aromatics in catalysts of a metal from Group 10 are 200 to 400° C., preferably 200 to 300° C. Above 300° C., the chemical equilibrium of hydrogenation is already evident, when increases in temperature mean less hydrogenation, under typical conditions of operating pressure, usually less than 100 bar (10 MPa). In addition, higher pressures of up to 200 bar (20 MPa) can be used.

Desirable pressure conditions are charge dependent. It is preferable to maintain the alkylation pressure above the critical pressure of the mixture. In the case of mixing toluene with LPG, the desirable pressure is greater than 55 bar (5.5 MPa). The critical temperature is around 250° C.; so, in most of the operation, the deposition of oligomers in the reactor will be reduced due to the higher diffusivities in supercritical medium. In practice, pressures greater than 30 bar (3.0 MPa) are preferable, preferably in the range of 60 bar (6 MPa), and pressures of up to 100 bar (10 MPa) are sufficient. For hydrogenation, it was found that in the present invention maintaining the same operating pressures as the alkylation allowed for the desired hydrogenation of alkyl-aromatics to alkyl-naphthenics.

The LHSV (volume of charges fed per reactor volume per hour) depends on the nature of the charges, pressure conditions, temperature and desirable campaign time before a regeneration step. A typical LHSV is from 0.1 to 10 h⁻¹, preferably from 0.5 to 4 h⁻¹, more preferably from 1 to h⁻¹, for both hydrogenation and alkylation, although typically the LHSV conditions of the hydrogenation may be greater than those of alkylation.

The typical operating times before regeneration is required are at least 2 days to 1 month, typically 4 days to 2 weeks. Too long before regeneration can build up polymers on the surface in a way that makes it difficult to access the metal sites needed for catalyst regeneration. Also, too long time between regenerations can mean too low LHSV, and larger reactor sizes for a given charge, which is undesirable.

The typical regeneration conditions are higher than those employed in alkylation, typically from 250 to 500° C., more preferably from 350 to 450° C., and not higher than 550° C. The regeneration pressure can be the same or less than that used in alkylation. Greater pressures prove unnecessary. More preferably, the reactor in the regeneration step operates in a down-flow mode, in order to facilitate the flow of the liquid that previously wet the catalyst. The amount of required hydrogen is small, being 1 volume of H₂ under normal conditions of temperature and pressure, per reactor per minute, preferably 10 volumes of H₂ per reactor volume per minute, which is equivalent to a GHSV of at least 60 at 600 h⁻¹, which may be higher depending on the need to heat the catalyst bed under the conditions necessary for the regeneration of the catalyst of the present invention.

The catalyst of the present invention contains both acidic and hydrogenating functions. The catalyst has a hydrogenating function and has a metal from Group 10 of the Periodic Table, preferably Pt and/or Pd, plus at least one metal from Group 9, such as Rh, and/or Group 7, such as Re.

The contents of metals from Group 10 are typically 0.1 to 5% w/w, more preferably 0.2 to 1% w/w, most preferably 0.6% w/w. Higher metal contents are unnecessary for complete catalyst regeneration, and decrease the availability of acidic sites.

The contents of metals from Group 9 and/or Group 7 are typically 0.05 to 2% w/w, more preferably 0.1 to 0.5% w/w, more preferably 0.2% w/w.

Preferably, the metals are prepared with precursors without chlorine or any other halides in the composition, which will add chlorine content to the catalyst.

Several catalysts of acidic nature can be used in the present invention, such as alumino-silicates, amorphous or crystallines. In general, silica-aluminas, large-pore zeolites in acidic form, such as ferrierites, chabazites, Y, US-Y, RE-Y, ZSM-5, ZSM-12, NU-86, mordenites, ZSM-22, NU-10, ZBM-30, ZSM-11, ZSM-47, ZSM-35, IZM-2, ITQ-6, IM-5, SAPO (silico-aluminum-phosphates), Beta zeolite, MCM-22, MCM-56, molecular sieves can also be phosphated or silanized (treated with siloxanes), clays, pillared clays, mixed metallic oxides, acidic ion exchange resins, sulfonated silicas, phosphated niobium.

FIG. 1 presents a preferred arrangement of the present invention. A stream containing olefins (1) is sent to a reactor (10), part of which is mixed with the charge (2) containing aromatics. In reactor (10), there are at least 2 beds, with part of the olefin injection being carried out after the first bed. Further, in addition to charges (1) and (2), a recycle (22) of product aromatics, obtained from the fractionation of the product stream (11) in a fractionator (20), is added. The bottom product (23) of the fractionator follows to an aromatic hydrogenation unit (30), where hydrogen (3) is added for the reaction, obtaining alkyl-naphthenics (31), or a mixture of alkyl-naphthenics and alkyl-aromatics, in case of partial hydrogenation. While reactors (10) and (30) are dedicated to alkylation and hydrogenation, a reactor (40) is regenerated by the hydrogen stream (4).

Whereas the scheme of FIG. 1 is preferred, other operating schemes are possible, for example alkylation, product accumulation and hydrogenation in the same reactor, followed previously or later by a step of regeneration of the acidic function of the catalyst.

Preferably, the streams sent to the hydrogenation step contain little sulfur, preferably below 500 ppm, in order to allow the use of metals from Group 10 for the aromatics hydrogenation step. Otherwise, the hydrodesulfurization reaction (HDS) in catalysts such as sulfided CoMo and NiMo is known to those skilled in the art. While sulfur removal is unfavorable in the case of olefinic streams due to undesired saturation of olefins, it can be used after alkylation, before the hydrogenation step, once the olefins are converted. The same catalyst could be used for HDS and hydrogenation, but separation is preferable in a subsequent step of hydrogenation of aromatics after removal of sulfurs, since the activity of sulfided catalysts for hydrogenation of mono-aromatics is low. The alkylation step is not significantly affected by the presence of sulfur, and sulfur-containing charges can be processed. The presence of other contaminants, however, such as nitrogenous ones, can decrease the time of the alkylation campaign, and it can be advantageous to previously remove at least part of these compounds by means known in the art, such as adsorption, washing of the stream, etc. In one scheme of the present invention, as the regeneration is fast compared to the time of the alkylation campaign, the regenerated bed can be used as a trap, at temperatures lower than the alkylation, and be regenerated again before the alkylation step itself.

In addition to the fixed bed schemes described in the present invention, fluidized beds or transported beds can be used. However, such a reaction scheme is unnecessary, since the recovery nature of the alkylation activity of the present invention allows for simpler fixed bed operation, and the greater difficulty of providing means for solids movement is unnecessary.

In the particular condition of the invention of increasing the temperature from the alkylation condition to the regeneration condition, it can be done by processing aromatic or paraffinic charge, up to the desired temperature, or by heating the hydrogen stream itself, or even the mixture from the hydrogen stream with inert stream, such as paraffinic C4. Means for heating, achieving and maintaining the regeneration condition are known in the art, and various schemes can be employed without departing from the regeneration claim of the present invention. As with heating, lowering the temperature is also employed by means known in the art in order to process the alkylating charge after regeneration.

### EXAMPLES

The following examples are presented in order to illustrate some particular embodiments of the present invention, and should not be interpreted as limiting the same. Other interpretations of the nature and mechanism of obtaining the components claimed in the present invention do not change its novelty.

Experiments were carried out using refinery charges and model compost. To facilitate the analysis of the products, as aromatics, toluene was used, and as olefins, liquefied petroleum gas (LPG), containing mostly C4, with a total of 59.9% w/w in olefins, coming from the FCC unit.

The tests were conducted in an automated benchtop unit (PID). LPG and toluene were mixed in line, with independent pumps. The unit had N₂ flow pressurization at the top of the separator vessel. Thus, the unit was pressurized upstream without contacting the catalyst with the gas, being able to maintain the desired pressure from the beginning of the tests. Also, before entering the gas-liquid separator, the reactor effluent, after cooling to room temperature, went through a loop to the chromatograph, for in-line analysis, without loss of light. A chromatograph with a mass detector and FID was used to identify and quantify the products. Gaseous effluent was also analyzed and quantified, and no significant amounts of light were formed in addition to those already present in the charge.

5 ml of catalyst were used for each run, diluted in 5 ml of carborundum (SiC₂). The catalysts when extruded were broken in length one by one, maintaining the diffusion size (length not lesser than the diameter), for reasons of hydrodynamics and mass transfer. The packaging, particle and reactor diameter ratios and minimum bed length for a high conversion (in the range of 95%) followed scale-down criteria for trickle-bed and liquid phase reactors, to guarantee representativeness of the larger scale even in a micro reactor.

Typical alkylation temperatures were used, from 90 to 360° C. The pressures used aimed to maintain the liquid phase and, preferably, in a condition close to critical or supercritical. Critical point estimation using process simulator for a typical charge composition (50 vol % LPG and 50 vol % toluene) showed that the critical pressure was approximately 55 bar (5.5 MPa) and the critical temperature above 250° C. LHSV conditions were varied from 0.5 to 4 h⁻¹.

In all tests the catalytic bed was initially fed with aromatic (toluene) before feeding the specified flow rate of olefin.

### Example 1: Test of State-of-the-Art Supports, without Addition of Hydrogenating Function

Representative catalysts of 5 classes of acidic catalysts were tested. A commercially available divinyl-benzene macroporous resin (DVB resin) in the H form (various sources such as Duolite C20, Duolite C26, Amberlyst 15, Amberlyst 35, Amberlite IR-120, Amberlite 200, Dowex 50, Lewatit SPC 118, Lewatit SPC 108, Bayer K2611, K2621, OC1501, among others), a niobium phosphate mass catalyst (NbPO₃), a Silica-Alumina (SiAl), an acid mixed oxide, titanium and cerium in sulfated zirconia (TiZrSCe), and a prepared zeolite for the production of oligomers, based on H-ZSM5 (Zeolite).

Tests were performed under various conditions of T, LHSV from 0.5 to 4 h⁻¹, and typical charge of 50 vol % toluene+50 vol % LPG, with some tests ranging from 20 to 90% aromatic. The base pressure was 60 bar (6 MPa).

The divinyl-benzene resin (DVB resin) was tested at a temperature of 60 to 140° C. (due to catalyst limitations). The NbPO₃ catalyst was tested from 140 to 250° C. The SiAl catalyst was tested mostly from 200 to 280° C., with some tests up to 380° C. to assess accelerated deactivation. The TiZrSce catalyst has been tested from 140 to 360° C. The zeolitic catalyst was tested from 200 to 320° C.

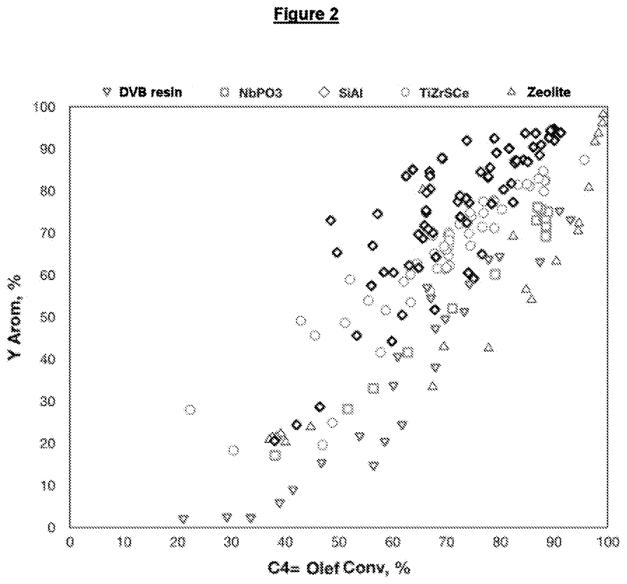

We analyzed the conversion of C4= olefins (C4= Olef Conversion, %) versus aromatics yield (Y Arom, %), and results presented in FIG. 2. The objective is the highest possible olefin conversion with the highest yield in aromatics, since the yield in C8= olefins is in the gasoline range, not JET A-1.

Observing the results, it appears that the divinylbenzene resin (DVB) produces mostly olefins, only increasing in conversions of higher olefins. NbPO₃ had a slightly higher yield in alkyl-aromatics, followed by TiZrSCe. On the other hand, zeolite showed high olefin conversions, but lower yields in alkyl-aromatics. It only showed high yields in alkyl-aromatics with high conversions at higher severities and higher aromatic/olefin ratios than the standard. SiAl silica-alumina combined the desired result of high conversions of olefins with high yields of alkyl-aromatics.

### Example 2: Doping with Pt, Pd, Rh and SiAl Catalyst Deactivation Test with and without Metallic Function

Metals were added to the original SiAl catalyst, by the wet spot impregnation technique, according to WO PCT patent 2001/09628. Drying was carried out in a muffle oven in two steps: 100° C. for 2 h and 140° C. for 2 h (after heating rate of 1° C./min). The calcination was carried out in a muffle furnace in 2 steps, at 300° C. for 2 h and 500° C. for 2 h (at 5° C./min).

The original catalyst: 0% metals, only silica-alumina, state of the art.

State of the art catalyst A: 0.2% w/w Pt, 0.6% w/w Pd, prepared with chlorine salts, totaling 0.47% w/w of Cl in the catalyst.

State of the art catalyst B: 0.2% w/w Pt, 0.6% w/w Pd, prepared with non-chlorine salts in the composition.

The catalyst of the present invention C: 0.2% w/w Pt, 0.4% w/w Pd, and 0.2% w/w Rh, prepared without chlorine salts.

Prior to contact with the charge, the catalysts were reduced after loading in the unit at 400° C. for 4 h at 60 bar (6 MPa).

Tests were carried out to verify the deactivation of the catalysts loaded with LPG+toluene (50/50 vol %), temperature of 230° C., pressure of 60 bar (6 MPa) and LHSV of 2 h⁻¹.

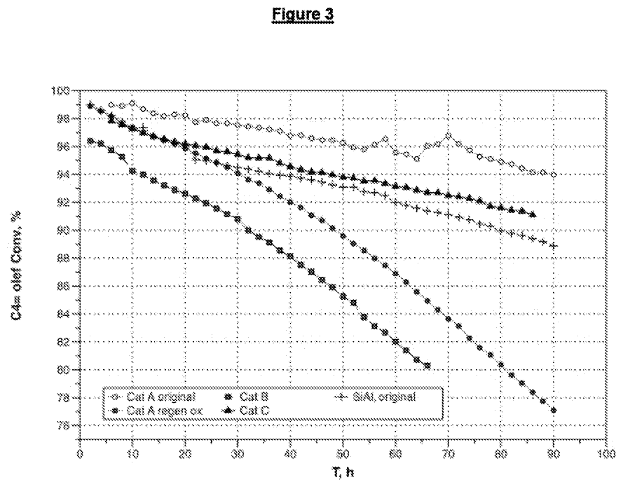

FIG. 3 shows the comparison of the first alkylation results (first tests of the catalysts) after the standard reduction procedure, even for the original catalyst, without metals. Catalyst A (PtPd with chlorine) showed greater activity and less deactivation than the original SiAl, but, after oxidative regeneration (Cat A regen Ox), it showed greater deactivation than the original SiAl catalyst. The catalyst B (PtPd without chlorine) showed lower activity than the original SiAl and similar deactivation to the regenerated A. On the other hand, catalyst C showed higher activity than original SiAl, and a lower deactivation tendency than regenerated A, B and original SiAl. The catalyst C of the present invention is more active and with less deactivation than the original support.

Not only the initial activity and deactivation are important, it is necessary that the hot-stripping procedure with H₂ of the present invention is effective to recover the initial activity of the catalyst and thus allow the catalyst to operate for a long term, avoiding regeneration with oxygen.

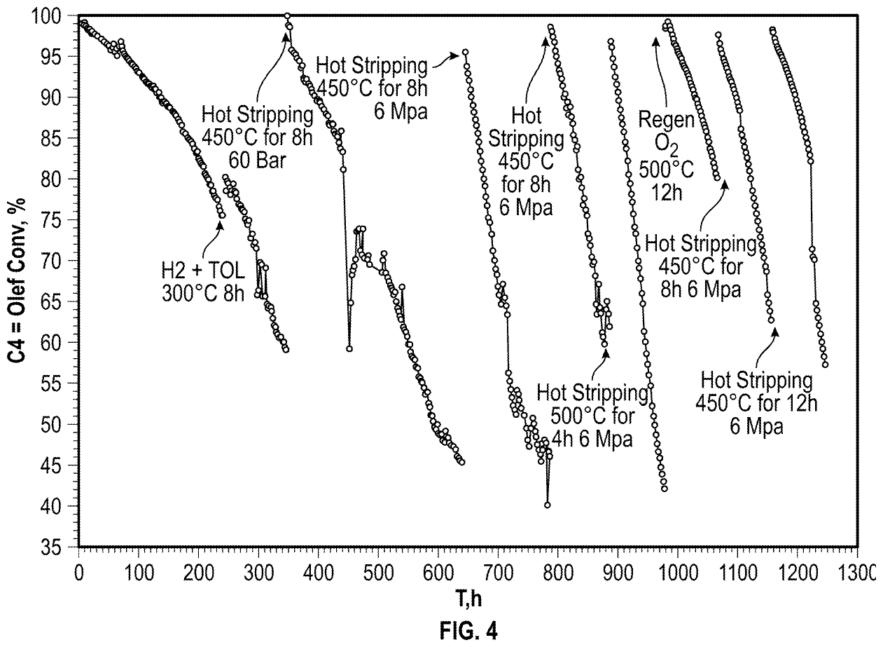

FIG. 4 shows the results for catalyst A, PtPd with chlorine. A first regeneration attempt was carried out, maintaining the flow only of toluene at 300° C. for 8 h (and with enough H₂ excess for 3 times the chemical consumption of hydrogenation). The objective was to verify the impact of the hydrogenation step on the catalyst regeneration. For catalyst A, hot-stripping was performed (passage of H₂ in the reactor, 10 volumes of H₂ per volume of catalyst per minute, for 8 h) at 450° C. after about 350 h, new hot-stripping after 650 h, and a third hot-stripping at 890 h; followed by oxidation regeneration at 980 h (depressurizing, injecting air and N₂ mixture, maintaining 500° C. for 12 h), followed by hot-stripping at 1060 h and 1150 h, as shown in FIG. 4. The results show that the state-of-the-art catalyst with chlorine deactivated more after each hot-stripping step and that the initial activity was not recovered after oxidative regeneration.

For the state-of-the-art catalyst B, without chlorine, hot striping was performed at 60 h, at 130 h, at 195 h (both at 450° C., the first 2 for 12 h and the third for 24 h). Activity results were similar to the initial test. However, with significantly lower activity than SiAl without metals, and worse than the activity of catalyst A after oxidative regeneration.

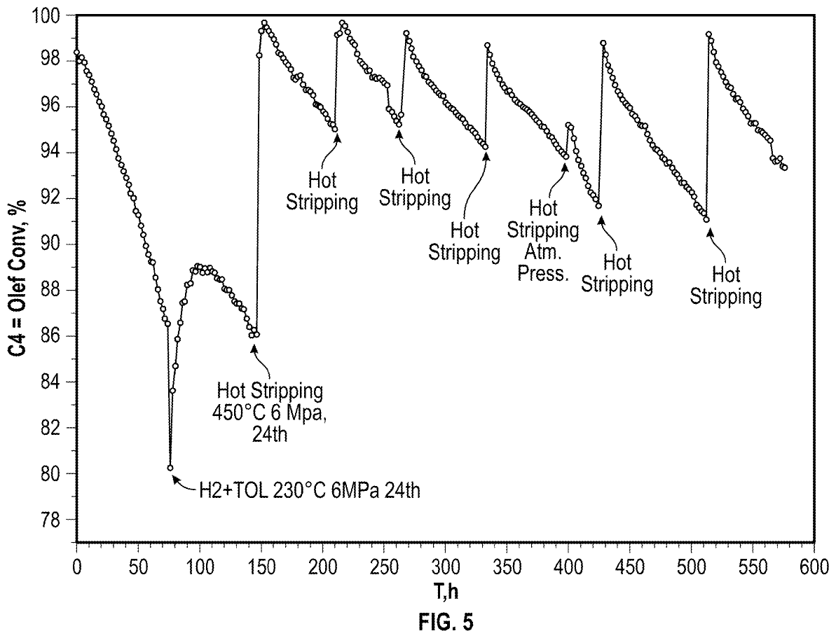

FIG. 5 shows the results of regenerations with H₂ for the catalyst C of the invention, from PtPd+Rh. a first regeneration attempt was performed at 70 h, with toluene and H₂, at 230° C., 60 bar (6 MPa), for 24 h (and with enough excess of H₂ for 3 times the chemical consumption of hydrogenation). Recovery of part of the activity occurred, with an increase over time, which may indicate that the hydrogenation was able to convert part of what deactivated the catalyst, which was removed over time during the alkylation step. This behavior indicates that longer hydrogenation times will likely continue to reactivate the acidic function of the catalyst, even at lower temperatures, compatible with the hydrogenation of aromatics. Test continued until about 145 h, when hot-stripping was performed at 450° C. for 24 h and 60 bar (6 MPa). The same hot stripping was performed at 220 h, 270 h, 330 h. At 400 h, a hot-stripping was performed for 24 h at atmospheric pressure, but with insufficient activity recovery, the hot-stripping was repeated at 425 h, followed by another at 515 h, as shown in FIG. 5.

Surprisingly, there is no tendency for the deactivation to deteriorate with the continuation of the tests, and the hot-strippings at a temperature higher than the alkylation and pressure equal to the alkylation (450° C. and 60 bar (6 MPa)) were sufficient for the full recovery of the activity of the catalyst, for at least 6 operating cycles. The results indicate that a high number of regenerations with H₂ (hot stripping) can be used before the need for oxidative regeneration.

The result of the invention of the addition of Rh to the alkylation catalyst containing Pt/Pd, even in a small amount, 0.2% w/w, in the recovery of activity by hot-stripping is surprising and unexpected.

The alkylation products obtained in the tests were collected for final hydrogenation tests.

### Example 3: Use of Catalysts for the Hydrogenation Step

It was possible to hydrogenate the hydrogenation products obtained in the alkylation step using catalysts B and C.

The catalysts were compared to a hydrogenation catalyst formulation stream in the diesel range, described in WO PCT 2001/09628, and showed similar results.

### Example 4: Formulation with Re

Preparing catalyst D with Re (0.2% w/w Pt, 0.4% w/w Pd and 0.2% w/w Re) showed similar results to catalyst C in the alkylation, but with lower dealkylation in the hydrogenation step.

The examples illustrate the claims of the present invention of conversion by alkylation of aromatics and olefinic chains to alkyl-aromatics and alkyl-naphthenics, using a regenerable catalyst, and should not be limiting thereto.

1. A process for obtaining alkyl-naphthenics, comprising:
(a) alkylating aromatics with olefins using an acid-supported alkylation catalyst with at least one metal from Group 10 of the Periodic Table of Elements, plus at least one metal from Group 9, and/or Group 7;
(b) regenerating the activity of the alkylation catalyst by contacting the alkylation catalyst with H₂ at a temperature higher than the alkylation reaction performed in step (a);
(c) repeating step (a) at least once using the regenerated alkylation catalyst produced in step (b).

2. The process according to claim 1, wherein the acid support of the alkylation catalyst is selected from at least one of aluminosilicates, amorphous or crystallines.

3. The process according to claim 2, wherein the acid support of the catalyst is selected from silica-aluminas, large pore zeolites in acidic form, such as ferrierites, chabazites, Y, US-Y, RE-Y, ZSM-5, ZSM-12, NU-86, mordenites, ZSM-22, NU-10, ZBM-30, ZSM-11, ZSM-47, ZSM-35, IZM-2, ITQ-6, IM-5, SAPO (silico-alumino-phosphates), Beta zeolite, MCM-22, MCM-56, phosphated or silanized molecular sieves treated with siloxanes, clays, pillared clays, mixed metallic oxides, acidic ion exchange resins, sulfonated silicas, and phosphated niobium.

4. The process according to claim 1, wherein the contents of metals from Group 10 are from 0.1 to 5% w/w and metals from Group 9 and/or Group 7 are from 0.05 to 2% w/w.

5. The process according to claim 4, wherein the contents of metals from Group 10 are from 0.2 to 1% w/w and metals from Group 9 and/or Group 7 are from 0.1 to 0.5% w/w.

6. The process according to claim 5, wherein the contents of metals from Group 10 are 0.6% w/w and metals from Group 9 and/or Group 7 are 0.2% w/w.

7. The process according to claim 1, wherein the effluent from the alkylation step is sent to the hydrogenation reaction of alkyl-aromatics to alkyl-naphthenics, using a hydrogenation catalyst.

8. The process according to claim 1, wherein the operating conditions of the alkylation reaction comprise a temperature between 100 and 400° C.; a pressure between 30 and 200 bar (3 and 20 MPa); and an LHSV between 0.1 and 10 h⁻¹.

9. The process according to claim 8, wherein the operating conditions of the alkylation reaction comprise a temperature between 150 and 350° C.; a pressure between 30 and 100 bar (3 and 10 MPa)); and an LHSV between 0.5 and 4 h⁻¹.

10. The process according to claim 9, wherein the operating conditions of the alkylation reaction comprise a temperature between 200 and 300° C.; a pressure of 60 bar (6 MPa); and an LHSV between 1 and 2 h⁻¹.

11. The process according to claim 1, wherein the catalyst regeneration reaction is performed with super-atmospheric hydrogen, preferably with the same operating pressure as the alkylation.

12. The process according to claim 1, wherein the alkylation catalyst is contacted with H₂ for between 4 h and 48 h.

13. The process according to claim 12, wherein the catalyst contact with H₂ is between for 8 and 36 h.

14. The process according to claim 13, wherein the catalyst contact with H₂ is for 24 h.

15. The process according to claim 1, wherein the regeneration step is performed using H₂ is with a temperature between 250 and 500° C.

16. The process according to claim 15, wherein the regeneration step is performed using H₂ is with a temperature between 350 and 450° C.

17. The process according to claim 16, wherein the regeneration step is performed using H₂ with a temperature of is up to 550° C.

18. The process according to claim 1, wherein the regeneration of the alkylation catalyst performed in step (b) is carried out in the presence of the alkylation product with an excess of hydrogen, resulting in alkyl-naphthenics.

19. The process according to claim 1, wherein
a) the at least one metal from Group 9 comprises rhodium; and/or
b) the at least one metal from Group 7 comprises rhenium.
